(19) United States
(12) Patent Application Publication
(10) Pub. No.: US 2007/0054615 A1
(43) Pub. Date: Mar. 8, 2007

(54) Metadata provision system and method

(75) Inventors: Paul R. Marshall, Redhill (GB); Andrew J.M. Wishart, Godstone (GB); David A. Baker, Didcot (GB); Daniel A. Van Den Heever, Cambridge (GB)

Correspondence Address: PHILIPS INTELLECTUAL PROPERTY & STANDARDS, P.O. BOX 3001, BRIARCLIFF MANOR, NY, 10510, US

(73) Assignee: koninkijkle phillips electronics n.v.

(21) Appl. No.: 10/539,899

(22) PCT Filed: Dec. 5, 2003
(86) PCT No.: PCT/IB03/05755

§ 371 Date: Jun. 16, 2005

(30) Foreign Application Priority Data
Dec. 18, 2002 (GB) 0229535.0

(51) Int. Cl. H04H 7/00; H04B 1/18

(52) U.S. Cl. 455/3.06; 455/152.1

(57) ABSTRACT

A metadata provision system and method is described. The system comprises a transmitter (30) and a receiver (60). The transmitter (30) is arranged to transmit metadata corresponding to content data. The receiver (60) is arranged to receive the transmitted metadata, wherein the receiver (60) is arranged to store the metadata and output the metadata upon request. Preferably the transmitter (30) and receiver (60) operate under the Digital Audio Broadcasting system.

The present invention relates to a system and method capable of providing metadata to a destination lacking data network connectivity. The present invention is particularly applicable to the provision of metadata to in-car entertainment systems.

Many users own an audio system for playing music and, more recently, multimedia. Audio systems commonly have to ability to play audio recorded on, for example, CD (Compact Disc) and/or MD (Mini Disc) storage media. Each media type has its own pre-defined specification and data encoding format defining the manner in which audio tracks should be written. More recently, different file formats for encoding music have been utilized such as MP3 and WMA. These formats allow many more music files (commonly referred to as tracks) to be stored on a single storage media.

Other audio systems are also available that use hard disks or other memory devices such as solid state memory devices to store the music files.

In each case, the number of music files a single device or recording medium can store is increasing dramatically. In the past, a CD purchased from a retail store would typically only store between 8 and 15 tracks and it was relatively simple to scan through the tracks to find the particular one you wished to hear. However, with some systems offering storage capacities in excess of 1 Gb, hundreds, if not thousands, of tracks can be stored in a single device or on a single storage medium in an immediately accessible manner. Whilst such systems remove the requirement of changing CDs or other media if the desired track is not on that particular media, tracks are no longer conveniently divided between a number of CDs or other media. In the past, this division offered the benefit of simplifying searching and organizing music collections.

It is common for tracks and compilations of tracks to have additional information associated with them such as the title of the track, name of the artist, title of the compilation, name of the song writer etc. This additional information can be referred to as metadata, that is, a definition, description or other data concerning the original data. In the past, such metadata is provided in the form of a printed insert to the storage media case or part of the packaging itself. However, when many tracks or compilations are merged onto a single device or storage medium this metadata is lost.

Displaying the metadata whilst playing the track is of use to a user as a desired track can be selected without having to listen to each track in turn. In addition, the display of metadata allows a user to obtain information on a track he or she may not have heard before or may have forgotten.

One source that provides metadata is www.gracenote.com. The Gracenote system provides a very large online database of metadata that is said to cover over 800,000 music albums and over 10,000,000 individual songs. Software programs or embedded systems within storage devices are now commonly arranged to access the online database via the internet to obtain metadata associated with the respective track or album.

The main disadvantage of systems such as Gracenote is that internet access is required in order to obtain metadata.

According to a first aspect of the present invention, there is provided a metadata provision system comprising a transmitter and a receiver, the transmitter being arranged to transmit metadata corresponding to content data and the receiver being arranged to receive the transmitted metadata, wherein the receiver is arranged to store the metadata and output the metadata upon request.

The present invention seeks to provide a method and system in which metadata can be provided to a destination that lacks data network connectivity.

Preferably, the content data comprises audio data, the receiver including a media player, the request comprising presentation of the audio data in the media player. Preferably, the media player comprises a car head unit.

The transmitter may comprise a local transmitter arranged to transmit metadata to a receiver when the receiver is within a predetermined area. Power to the transmitter may be controlled to limit transmission to the predetermined area.

Preferably, the transmitter and receiver operate under the Digital Audio Broadcasting standard.

By using DAB systems, existing transmitter coverage can be used, thereby reducing implementation costs.

The transmitter and receiver may alternatively operate under another wireless data network such as BlueTooth, IEEE 802.11 or ZigBee.

The transmitted metadata may be encrypted.

According to another aspect of the present invention, there is provided a method of providing metadata comprising:

transmitting metadata corresponding to content data from a transmitter over a wireless data network;

receiving the transmitted metadata at a receiver;

storing the metadata at the receiver; and,

output the metadata from the receiver upon request.

Examples of the present invention will now be described in detail, with reference to the accompanying drawings in which:

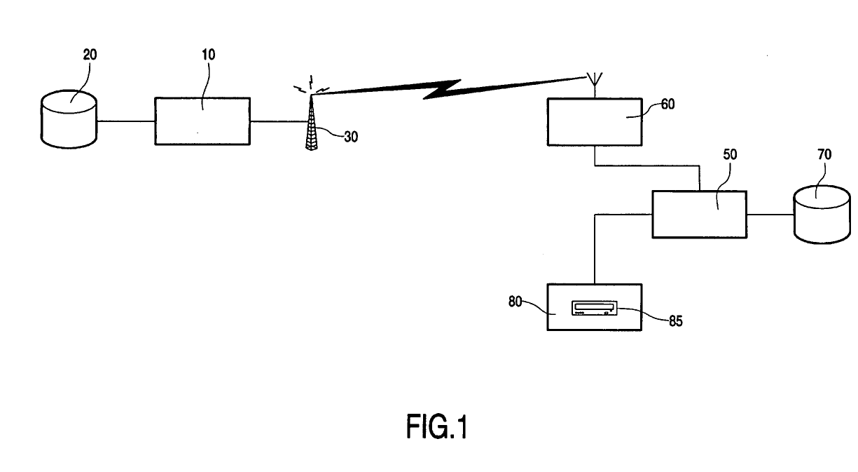

FIG. 1 is a schematic diagram of a metadata provision system according to one embodiment of the present invention; and,

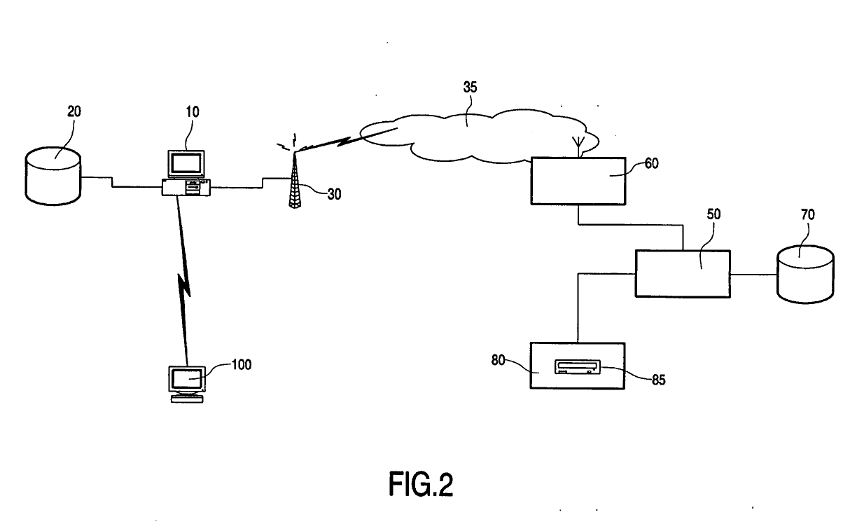

FIG. 2 is a schematic diagram of a metadata provision system according to another embodiment of the present invention.

FIG. 1 is a schematic diagram of a metadata provision system according to one aspect of the present invention.

The metadata provision system includes a metadata source 10 and a metadata receiver 50. The metadata source 10 includes a database 20 storing the metadata and transmitter 30 operating under the Digital Audio Broadcasting (DAB) standard. The DAB standard is detailed in ETSI document 300-401 available from www.etsi.org and is incorporated herein by reference. The metadata receiver 50 includes a DAB receiver 60 and a memory 70.

The database 20 transmits its metadata in a repeating loop via the transmitter 30 to the receiver 60. The received metadata is stored in the memory 70. As and when content is updated or new metadata is added, the memory 70 is updated accordingly. By transmitting the metadata in a repeating loop, it can be ensured that all metadata receivers 50 will receive updates at some point and they do not all have to be operational or in reception range of a transmitter 30 at once. In addition, universal metadata receivers 50 can be sold with blank memories 70 and relevant metadata would then be received over time from a localized transmitter 30. For example, in France the transmitter 30 would transmit metadata in French or possibly containing more metadata on French artists. However, the same technology could be used in the United Kingdom and the receiver 50 would receive different metadata relevant to the UK market.

The metadata receiver 50 is preferably coupled to, or incorporated in, an audio device such as a car head unit 80. In a preferred embodiment, the head unit 80 includes a media player 85 such as a CD or MD player. The contents of media input to the media player 85 can be selectively or automatically transferred to the memory 70. When media is input to the media player 85, an identifier is obtained and this is correlated with the metadata held in the memory 70 to obtain metadata on the media content. Typically, correlation would be via a predetermined identifier would be recorded on the media identifying the content. Alternatively, the contents table for the media may be used as the identifier.

The contents of the media are then transferred to the memory 70 and associated with any relevant metadata held.

When new metadata is received from the transmitter 30, in addition to being stored in the memory 70, it is compared with existing content stored in the memory and additional associations are recorded if necessary. When the particular content is played by the head unit 80 the associated metadata is displayed or otherwise used. The head unit 80 may also provide search facilities for content in dependence on associated metadata.

Preferably, the DAB transmission is encrypted using the conditional access mechanism discussed in detail in the DAB standard. In this manner, transmissions are encrypted and a flag indicating this is set in the data structures transmitted. The receiver 50 includes a pre-agreed decryption key that allows the metadata to be decrypted upon receipt. A one-off or periodic charge may apply in order to obtain the necessary decryption keys.

FIG. 2 is a schematic diagram of a metadata provision system according to a further embodiment of the present invention.

In this embodiment, the transmitter 30 is a low-powered local transmitter with only an extremely short communication range 35. For example, the transmitter may operate under a standard such as IEEE 802.11, ZigBee, BlueTooth or DAB. The user's PC or set top box functions as the metadata source 10 and database 20. The PC is connected to a metadata provider 100 from which new and updated metadata is obtained to update the database 20. This information is then communicated via the transmitter 30 and the receiver 60 to the memory 70 when it is in range.

It will be apparent to the reader that many variations and modifications to the system and method are possible. The memory 70 may be a hard disk or other recordable storage medium. In addition, the memory 70 may be composed of a number of storage media or memories itself. For example, there may be one hard disk dedicated to storing the metadata database and another for storing the content. In this scenario, the content may be linked to appropriate entries in the metadata database or the entries may be copied to the content hard disk when the content is recorded. In the case of MP3 or similar encoded CD's that the head unit and system may not be able to record to, the system may be arranged to access the metadata database for each track to be played and display this in real time.

Various mechanisms to limit the amount of data to be transmitted can also be envisaged. For example, when sold, the memory 70 of the receiver 50 may include a predefined metadata database that is subsequently added to. In this event, only subsequent additions would need to be transmitted by the transmitter 30 in the continuous loop. In another example, the memory 70 may only store metadata on content actually stored. In this manner, the identifier of any new content introduced would be stored and used to pick out the appropriate metadata when it is available.

1. A metadata provision system comprising a transmitter (30) and a receiver (60), the transmitter (30) being arranged to transmit metadata corresponding to content data and the receiver (60) being arranged to receive the transmitted metadata, wherein the receiver is arranged to store the metadata and output the metadata upon request.

2. A system according to claim 1, wherein the content data comprises audio data, the receiver (60) including a media player (85), the request comprising presentation of the audio data in the media player (85).

3. A system according to claim 1, wherein the media player (85) comprises a car head unit (80).

4. A system according to claim 1, wherein the transmitter (30) comprises a local transmitter arranged to transmit metadata to the receiver (60) when the receiver (60) is within a predetermined area (35).

5. A system according to claim 4, wherein power to the transmitter (30) is controlled to limit transmission to the predetermined area (35).

6. A system according to claim 1, wherein the transmitter (30) and receiver (60) operate under the Digital Audio Broadcasting standard.

7. A system according to claim 1, wherein the transmitter (30) and receiver (60) operate under a selected one of: BlueTooth, IEEE 802.11 or ZigBee.

8. A system according to claim 1, which the transmitted metadata is encrypted.

9. A method of providing metadata comprising:
transmitting metadata corresponding to content data from a transmitter over a wireless data network;
receiving the transmitted metadata at a receiver;
storing the metadata at the receiver; and,
output the metadata from the receiver upon request.

10. A method as claimed in claim 9, wherein the wireless data network comprises a selected one of a Digital Audio Broadcasting network, an IEEE 802.11 network, a ZigBee network or a BlueTooth network.
